(19) United States
(12) Patent Application Publication
(10) Pub. No.: US 2026/0328636 A1
(43) Pub. Date: Oct. 22, 2026

(54) METHOD FOR OPERATING A POWER DEVICE, CONTROL DEVICE FOR CARRYING OUT SUCH A METHOD AND POWER DEVICE INCLUDING SUCH A CONTROL DEVICE

(71) Applicant: Rolls-Royce Solutions GmbH, Friedrichshafen (DE)

(72) Inventors: Tobias Sturm, Pfullendorf (DE); Boris Bulatovic, Graz (AT)

(73) Assignee: Rolls-Royce Solutions GmbH, Friedrichshafen (DE)

(21) Appl. No.: 19/692,757

(22) Filed: May 29, 2026

Related U.S. Application Data
(63) Continuation of application No. PCT/DE2024/101009, filed on Nov. 27, 2024.

(30) Foreign Application Priority Data
Nov. 29, 2023 (DE) 10 2023 133 411.5

(51) Int. Cl. G01L 27/00; G01K 15/00

(52) U.S. Cl. CPC G01L 27/007; G01K 15/007

(57) ABSTRACT

A method for operating a power device includes the steps of: operating the power device in a first specified operating range; detecting a first diagnostic value of a sensor while the power device is operated in the first specified operating range; operating the power device in a second specified operating range, which is different from the first specified operating range; detecting a second diagnostic value of the sensor while the power device is operated in the second specified operating range; and evaluating a sensor behavior of the sensor by comparing the first diagnostic value and the second diagnostic value.

### CROSS REFERENCE TO RELATED APPLICATIONS

This is a continuation of PCT application no. PCT/DE2024/101009, entitled “METHOD FOR OPERATING A POWER DEVICE, CONTROL DEVICE FOR CARRYING OUT SUCH A METHOD, AND POWER DEVICE COMPRISING SUCH A CONTROL DEVICE”, filed Nov. 27, 2024, which is incorporated herein by reference. PCT application no. PCT/DE2024/101009 claims priority to German patent application no. 10 2023 133 411.5, filed Nov. 29, 2023, which is incorporated herein by reference.

### BACKGROUND OF THE INVENTION

### 1. Field of the Invention

The present invention relates to power devices.

### 2. Description of the Related Art

Generally, control devices are equipped with a multitude of sensors and are typically also operated depending on sensor values acquired by the sensors. Therefore, there is generally a need to recognize incorrect sensor values which can occur, for example, when a sensor is defective, blocked, dirty, contaminated or nonexistent. For example, it might not have been installed initially, or it might have been removed during maintenance and not reinstalled, or it might have been deliberately removed for tampering purposes. It is possible to verify the plausibility of sensor values recorded in a control device with the help of computational models or other sensors; however, additional tolerances and aging effects must be taken into account, so that threshold values used to evaluate sensor behavior are quite roughly defined. It is therefore not always possible to set such threshold values with sufficient sensitivity, which can regularly lead to problems if a sensor value changes only slightly over wide ranges, for example when verifying the plausibility of an intake vacuum of an internal combustion engine, where there is only a very small pressure change of, for example, −15 mbar between low load and full load.

What is needed in the art is a method for operating a power device, a control device for a power device, designed for carrying out such a method and a power device with at least one sensor and one such control device that is operatively connected with the at least one sensor, wherein the aforementioned disadvantages are at lease reduced, optionally avoided.

### SUMMARY OF THE INVENTION

The present invention relates to a method for operating a power device, a control device for a power device, designed for carrying out such a method and a power device with at least one sensor and one such control device that is connected with the at least one senor.

The present invention provides a method for operating a power device, wherein the power device is operated in a first specified operating range, wherein a first diagnostic value of a sensor is detected while the power device is operated in the first specified operating range, wherein the power device is operated in a second specified operating range that is different from the first specified operating range, wherein a second diagnostic value of a sensor is detected while the power device is operated in the second specified operating range, and wherein the sensor's behavior is evaluated—in particular automatically—by comparing the first and second diagnostic values. The evaluation of the sensor behavior is thus advantageously based on a comparison of sensor values, namely the diagnostic values, in different operating ranges of the power device, whereby any tolerances, drifts and/or aging effects compensate for each other, since values of the same sensor are always compared promptly with each other. Thus, a sensitive evaluation can also be performed for those sensors in which only small changes in the detected sensor values occur; in particular, threshold values used for the evaluation can be parameterized sensitively. The method can also be easily implemented and requires no complex and expensive additional sensors or complicated computational models for evaluating a specific sensor. While not wishing to be tied to theory, the method is based on the premise that a sensor, if correctly installed and functioning, will register different sensor values in different operating ranges of a power device. From a comparison of these sensor values assigned to the various operating ranges, it can be determined as to whether the sensor is correctly installed and functional. For example, a sensor value detected in a control device would be constant, or at least almost constant within the range of noise, if the associated sensor were not installed or were blocked, because no real measured values would be detected and the noise of the sensor value in the control device does not depend on the current operating range of the power device.

Within the scope of the herein method of the present invention, the power device does not have to be specifically placed in the predetermined operating ranges. It is sufficient to detect the diagnostic values whenever the power device is operated—that is, during normal operation in the relevantly assigned operating ranges. This means that the method can be carried out easily during the normal operation of the power device and is not limited to special test, maintenance, or test bench runs.

It is possible that in more than two specified operating areas, respectively assigned diagnostic values are detected. Additional diagnostic values detected in additional operating ranges can contribute advantageously to the plausibility check or to increasing the accuracy of the evaluation of the behavior of the sensor.

However, one embodiment provides that only the first diagnostic value in the first operating range and the second diagnostic value in the second operating range are detected. Therefore, no additional operating ranges are used for the evaluation of the sensor behavior in this embodiment.

A further development of the present invention provides that the first operating range and the second operating range are selected so that the first diagnostic value and the second diagnostic value differ from one another by more than a specified distance value when the sensor is operational. The sensor can thus be advantageously evaluated with high accuracy, especially if the specified distance value is greater than an expected noise signal.

In particular, the first and second operating ranges are adapted to the sensor in such a way that the first and second diagnostic values differ by more than the specified distance value when the sensor is operational. This advantageously considers the specific characteristics and/or application range of the respectively considered sensor.

Thereby, and especially when defining the specified distance value, it is beneficial to consider how much the detected sensor value is expected to change depending on the operating range of the power device. Therefore, the first and second operating ranges, as well as the specified distance value, can be selected differently depending on the specific sensor under consideration and/or its area of application.

A further development of the present invention provides that the operating ranges are load ranges. This represents a particularly advantageous arrangement of the method, since sensor values can typically change significantly depending on the load of a power device.

In one embodiment, a lower load is assigned to the first specified load range than to the second specified load range. This advantageously ensures a particularly pronounced or significant difference in the detected diagnostic values.

Alternatively, or in addition, at least one load range, selected from the first specified load range and the second specified load range, is limited by a respective lower speed limit and a respective upper speed limit. The speed is thereby a particularly suitable parameter for determining a load range of a power device, especially an internal combustion engine. Optionally, both load ranges are limited by a respective lower speed limit and a respective upper speed limit. The speed limits can be configured as characteristic lines or curves.

Alternatively, or in addition, at least one load range, selected from the first specified load range and the second specified load range, is limited by a respective lower torque limit and a respective upper torque limit. Torque is also a particularly suitable parameter for determining a load range of a power device, especially an internal combustion engine. Optionally, both load ranges are limited by a respective lower torque limit and a respective upper torque limit. The torque limits can be designed as characteristic lines or curves.

In an optional embodiment, the at least one load range is limited by a respective lower speed limit, a respective upper speed limit, a respective lower torque limit, and a respective upper torque limit. It is possible that the at least one load range is defined as a rectangle in a load diagram of the power device, spanned on the one hand by the speed and on the other hand by the torque. Optionally, both load ranges are limited by a respective lower speed limit, a respective upper speed limit, a respective lower torque limit and a respective upper torque limit, whereby they are optionally defined as a rectangle in the load diagram of the power device, spanned on the one hand by the speed and on the other hand by the torque. However, the load ranges do not have to be parameterized as rectangles. Rather, their torque and/or speed limits can also be parameterized as characteristic curves that deviate from a constant progression, that is, from the horizontal or vertical straight line in the load diagram, and in particular can be curved, at least in some sections, defining lower and upper load thresholds. The characteristic curves can have any curve progression. In one arrangement, the torque limits can be parameterized as characteristic curves that deviate from a constant progression, optionally curved at least in some areas, while the speed limits are designed as constants.

Alternatively, or additionally, a finite speed interval is provided between a first upper speed limit of the first specified load range and a second lower speed limit of the second specified load range This advantageously ensures a clear, concise, or significant difference in the detected diagnostic values.

Alternatively, or additionally, a finite torque interval is provided between a first upper torque limit of the first specified load range and a second lower torque limit of the second specified load range. This advantageously ensures a clear, concise, or significant difference in the detected diagnostic values.

In an optional arrangement, there is a finite speed difference between the first upper speed limit of the first specified load range and the second lower speed limit of the second specified load range. Additionally, there is a finite torque difference between the first upper torque limit of the first specified load range and the second lower torque limit of the second specified load range. If the load ranges are defined as rectangles in the load diagram spanned by the speed on the one hand and the torque on the other, in this case they are offset and spaced from each other along the speed axis on the one hand and along the torque axis on the other.

A further development of the present invention provides that a measured value of the sensor is detected as at least one diagnostic value, selected from the first diagnostic value and the second diagnostic value. This is an especially simple arrangement of the procedure.

Alternatively, the at least one diagnostic value is an average value derived from a plurality of sensor readings. This represents an especially accurate and reliable design of the method, which is less affected by outliers than if only a single measurement is used as the diagnostic value.

A further development of the method provides that a comparison is performed between the first and second diagnostic value by calculating a first difference between the diagnostic values and comparing the first difference with a specified minimum diagnostic difference. This provides a simple yet precise method for evaluating the sensor behavior.

In one embodiment, the sensor behavior is evaluated as “OK” if the first difference is greater than the specified minimum diagnostic difference. This advantageously results from the concept described above, that if the sensor is correctly installed and functional, a minimum change in the sensor value detected in the control device can be expected if the operating range of the load device changes. The specified minimum diagnostic difference can be defined differently depending on the specific sensor under consideration and/or its area of application. It can also be the same as, or different from the previously described distance value. Furthermore, the “OK” category can be defined the same as or differently from the “functional” category.

Alternatively, or additionally, the sensor behavior is evaluated as not “OK” if the first difference is less than the specified minimum diagnostic difference. This is based on the idea that something must be wrong with the sensor if a change in the operating range does not lead to a corresponding change in the detected sensor value. The fact that the sensor behavior is “not okay” can mean that the sensor is defective, blocked, dirty or contaminated, or that the sensor is completely nonexistent.

A further development of the present invention provides that for at least one operating range, selected from the first operating range and the second operating range, it is checked whether the power device is operated in the operating range for a specified operating range operating period, wherein the diagnostic value assigned to the operating range is only detected if the power device is operated in the operating range for the predetermined operating range operating period. Advantageously, this ensures that a steady-state operating behavior of the power device, and thus simultaneously of the sensor, has been established before the sensor behavior is evaluated. Otherwise, overshoots or the like could potentially occur during transient operation, for example, which would possibly impair the accuracy of the sensor behavior evaluation.

In one embodiment, a first specified operating range-operating duration is used for the first operating range, and a second specified operating range-operating duration is used for the second operating range. In one design it is possible that the first specified operating range operating duration and the second predetermined operating range operating duration is the same; in another arrangement however, the first specified operating range operating duration can also differ from the second predetermined operating range operating duration.

A further development of the present invention provides that in each of the operating ranges an environmental parameter value influencing or characterizing the respective diagnostic value is detected. This can advantageously contribute to ensuring that the observed sensor behavior is not significantly influenced by changed environmental conditions.

In one embodiment, it is checked by way of the detected environmental parameter values whether the evaluation of the sensor behavior could be disrupted by a change in the environmental parameter. For example, a change in ambient pressure can lead to a change in the detected sensor value of a pressure sensor, even if the operating range is kept constant, so that a comparison of the diagnostic values measured in the different operating ranges is no longer conclusive. Such a change in ambient pressure can occur, for example, when the altitude of the power device changes, for example, when traveling uphill or downhill.

In one arrangement, the sensor behavior of the sensor is only evaluated on the basis of the comparison of the first and second diagnostic values if it is determined on the basis of the detected environmental parameter values that the evaluation is not affected by the change in the environmental parameter. This approach, in particular, ensures that a meaningful and reliable statement about the sensor's behavior is made.

A further development of the present invention provides that the sensor's behavior is evaluated by comparing the first and second diagnostic values only if a second difference of a parameter difference between the environmental parameter values detected in the respective operating ranges is less than a specified maximum parameter difference. This is advantageously based on the idea that no meaningful and reliable statement about the sensor's behavior can be made if the second parameter difference exceeds the maximum parameter difference, indicating a significant change in environmental conditions. The specified maximum parameter difference can be defined differently depending on the specific sensor under consideration and/or its application range.

A further development of the present invention provides that the sensor is selected from a group consisting of a pressure sensor and a temperature sensor. The advantages described above are particularly evident with these sensors. However, the method is by no means limited to these sensors.

The present invention also provides a control device for a power device which is designed to carry out an inventive method or a method according to one or several of the previously described embodiments. The advantages that have already been described in connection with the method are also particularly evident in connection with the control device.

In one embodiment, the control device has at least one interface for operative connection with the at least one sensor.

Ultimately, the present invention also provides a power device that includes at least one sensor and an inventive control device that is operatively connected with the at least one sensor, or a control device according to one or more of the previously described embodiments, wherein the control device is designed to evaluate the sensor behavior of the at least one sensor. Regarding the power device, advantages arise in particular which were already described in connection with the method or the control device.

In the context of the present technical teaching a power device is understood to be in particular, a device which is arranged to provide power, in particular electrical and/or mechanical power, or to convert or consume power. The power device can thus be designed in particular as a power provision device or as a power conversion device. A power provision device is understood in particular to be a device that provides power, specifically electrical and/or mechanical power using electrical, mechanical, chemical, or electrochemical energy, or another form of energy. A power conversion device is understood to be, specifically, a device that uses or consumes power, specifically electrical or mechanical power, specifically to convert or store energy, for example, to use electrical energy to produce chemical energy in the form of certain substances, such as hydrogen or methanol, or to generate electrochemical energy. In various embodiments, the power device may in particular be an internal combustion engine, an internal combustion engine-generator combination device, in other words, a genset, a fuel cell, an energy storage device, in particular a battery, or an electrolysis device, in particular an electrolyzer. The power device may, however, also be a larger, complex system, for example consisting of a plurality of the aforementioned devices, or in particular a data center or a microgrid. In particular, the power device may also be a controllable or adjustable load on an electrical network.

In one embodiment, the power device includes a plurality of sensors, with the control device being operatively connected to the sensors and designed to evaluate the sensor behavior of each sensor. It is possible that the control device is designed to evaluate the sensor behavior of all sensors of the power device, but it is also possible that the control device is designed to evaluate only the sensor behavior of a selected number of sensors of the power device, while the power device includes further sensors whose sensor behavior is not evaluated by the control device. However, these other sensors can also be operatively connected to the control device in order to transmit sensor values to the control device and/or to be controlled by the control device.

The present invention also includes a vehicle that has a power device according to the present invention or a power device according to one or several of the embodiments described above. Regarding the vehicle, advantages arise in particular that have already been described previously in connection with the method, the control device, or the power device.

In one embodiment, the power device in the vehicle is a drive or part of a drive, in particular a motor or a device for providing drive power to an engine.

The vehicle is optionally selected from a group consisting of an excavator, a commercial vehicle or truck, a mining vehicle or construction vehicle, in particular an earth mover or dump truck, a rail vehicle, a maritime vessel, for example a yacht, a ferry or a submarine, and a military vehicle, in particular an armored vehicle, for example a combat tank, armored personnel carrier, armored reconnaissance vehicle, mine clearing vehicle or the like.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of a design example of a power device;

FIG. 2 is a schematic representation of operating ranges for a method for operating the power device; and

FIG. 3 is a representation of an embodiment of the method in the form of a flowchart.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

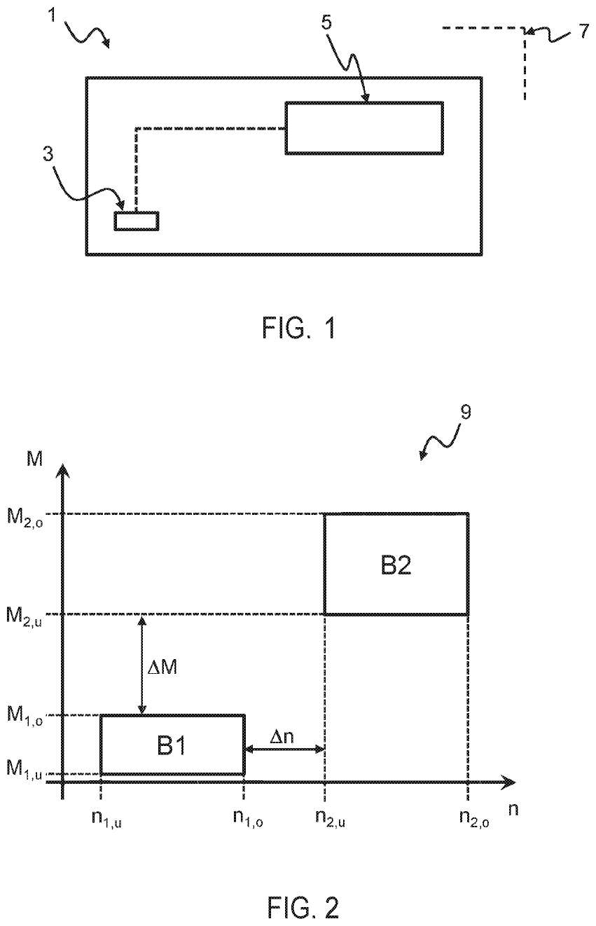

FIG. 1 is a schematic representation of a design example of a power device 1.

Power device 1 has at least one sensor 3 and at least one control device 5 which is operatively connected with the at least one sensor 3. Control device 5 is designed to evaluate the sensor behavior of the at least one sensor 3.

Power device 1 is optionally part of a vehicle 7 which is only schematically indicated. Power device 1 in vehicle 7 can be a drive or part of a drive, in particular an engine or a device for providing drive power to an engine. Vehicle 7 is optionally selected from a group consisting of an excavator, a commercial vehicle or truck, a mining vehicle or construction vehicle, in particular an earth mover or dump truck, a rail vehicle, a maritime vessel, for example a yacht, a ferry or a submarine, and a military vehicle, in particular an armored vehicle, for example a combat tank, armored personnel carrier, armored reconnaissance vehicle, mine clearing vehicle or the like.

Sensor 3 is optionally selected from a group consisting of a pressure sensor and a temperature sensor.

Control device 5 is optionally designed to carry out one embodiment of a method for operating power device 1 as described below.

FIG. 2 shows a schematic representation of operating ranges for a method for operating power device 1.

Identical and functionally equivalent elements are provided with the same reference symbols in all figures, so that reference is made to the preceding description in each case.

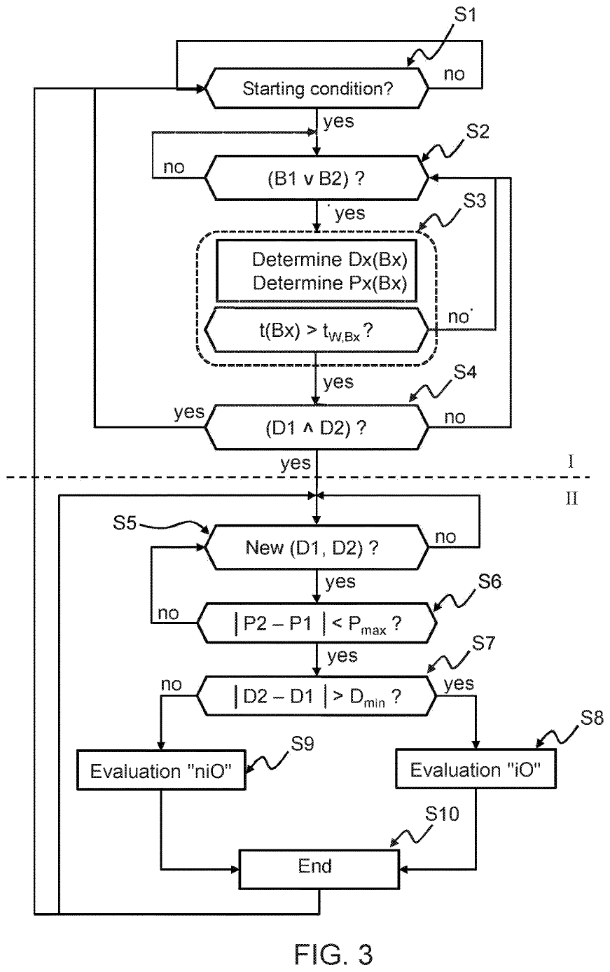

Within the scope of the method, power device 1 is operated in a first predetermined operating range B1, during which a first diagnostic value D1—see FIG. 3—of sensor 3 is detected while power device 1 is operating in first specified operating range B1. Power device 1 is also operated in a second specified operating range B2, which differs from first specified operating range B1, during which a second diagnostic value D2—see FIG. 3—of sensor 3 is detected while power device 1 is operating in second specified operating range B2. The sensor behavior of sensor 3 is evaluated—in particular automatically—by comparing first diagnostic value D1 with second diagnostic value D2.

First operating range B1 and second operating range B2 are optionally selected, in particular adapted, to sensor 3 so that first diagnostic value D1 and second diagnostic value D2 differ by more than a specified distance value when sensor 3 is operational.

In the design example shown here, operating ranges B1 and B2 are load ranges. First specified operating range, B1, is assigned a lower load than second specified operating range, B2. Operating ranges B1 and B2 are defined, by way of example, as rectangles in a load diagram 9 of power device 1, optionally designed as an internal combustion engine, which is defined on the one hand by a rotational speed n and on the other hand by a torque M. In additional examples, operating ranges B1 and B2 could also assume other geometric shapes, which can be defined arbitrarily by specifying the lower and upper torque limits M1,ᵤ, M,ₒ, M2,ᵤ, M2,ₒ. First predetermined operating range B1 is limited by a first lower rotational speed limit n_{1,u}, a first upper rotational speed limit n_{1,o}, as well as a first lower torque limit M_{1,u} and a first upper torque limit M1ₒ. Accordingly, second specified operating range B2 is limited by a second lower speed limit n_{2,u}, a second upper speed limit n_{2,o}, as well as a second lower torque limit M_{2,u} and a second upper torque limit M_{2,o}.

Between the upper speed limit n_{1,o} of first specified operating range B1 and second lower speed limit n_{2,u} of second specified operating range B2, there is a finite speed difference Dn=(n,ᵤ−n_{1,o}). Additionally, between first upper torque limit M_{1,o} of first specified operating range B1 and second lower torque limit M_{2,u} of second specified operating range B2, there is a finite torque difference Dn=(M2,_{2,u}−M_{1,o}).

FIG. 3 shows a representation of an embodiment of the method for operating power device 1 in the form of a flowchart.

The flowchart, and thereby also the method, is divided into an upper first part, designated I, and a lower second part, designated II. First part I and second part II of the method optionally run simultaneously and in parallel to each other, at least over wide ranges of the operation of power device 1, and are linked to each other in the manner described in more detail below.

The method starts in first step S1, in which at least one starting condition is optionally checked. The at least one starting condition can be selected in a way to contribute to preventing the evaluation process which may be rather slow on a time scale of a typical change interval between operating ranges of power device 1, from being repeated too frequently, which advantageously contributes to a debouncing of the evaluation. For example, a starting condition could be defined as the elapsed time since the last evaluation.

If the at least one starting condition is not met, first step S1 is repeated. If the at least one starting condition is met—in particular if several starting conditions or, where applicable, all starting conditions are met cumulatively—the process continues in second step S2.

It is checked in second step S2 if power device 1 is currently being operated in first operating range B1 or in second operating range B2. If power device 1 is not currently operating in either of these ranges, second step S2 is repeated. Otherwise, the method continues in third step S3.

Third step S3 includes a combination of sub-steps, carried out in parallel to each other: a first sub-step S3.1 and a second sub-step S3.2. In first sub-step S3.1, a diagnostic value Dx, that is, first diagnostic value D1 or second diagnostic value D2, assigned to current operating range Bx (that is, first operating range B1 or second operating range B2) is determined. Additionally, an environmental parameter value Px, such as ambient pressure, which influences or characterizes the respective diagnostic value Dx and is assigned to the current operating range Bx, is determined. In second sub-step S3.2, a time t(Bx) is monitored during which power device 1 is located in current operating range Bx. It is then checked whether power device 1 is operated in current operating range Bx for a predetermined operating range duration t_{W,Bx} assigned to the current operating range Bx.

If this is not the case, in other words, if operation of control device 1 in the current operating range Bx ends before the end of the assigned predetermined operating range operating time t_{W,Bx}, the procedure returns to second step S2, and diagnostic values Dx and environmental parameter values Px which were determined up to that point are discarded and thus not captured in the strict sense. Otherwise, the determined diagnostic values Dx and environmental parameter values Px are stored and thus captured in the strict sense for the further procedure; the method is then continued in fourth step S4.

Diagnostic value Dx can be a measured value of sensor 3 or a temporal average value of a plurality of chronologically consecutively measured values from sensor 3 over the specified operating range-operating time t_{W,Bx}.

In fourth step S4 it is checked whether a diagnostic value D1, D2, exists for each of the two operating areas B1, B2. On a repeated execution of the procedure, it is checked in fourth step S4 whether an updated diagnostic value D1, D2 exists for at least one of the two operating ranges B1, B2. If the test result in fourth step S4 is negative, the process returns to second step S2; if, however, the test result in fourth step S4 is positive, diagnostic values D1, D2, or at least updated diagnostic value D1, D2, are passed to fifth step S5, in the second part II of the procedure, and simultaneously the process returns to first step S1.

In the fifth step S5, it is checked whether initially any values at all are available or whether, in the event of repeats, at least a new or updated value for the diagnostic values D1, D2 exists. In one arrangement it is possible that the test result in the fifth step S5 is only positive if new or updated values are available for both diagnostic values D1, D2; in another arrangement, it is possible that the test result in the fifth step S5—in the case of repetition—is already positive if an updated value is available for one of the two diagnostic values D1, D2. If the test result is negative, fifth step S5 is repeated; if the test result is positive, the procedure is continued in sixth step S6.

In sixth step S6, the acquired environmental parameter values P1, P2 are used to check whether the evaluation of the sensor behavior can be negatively affected by a change in the environmental parameter. For this purpose, a difference value, referred to as a second difference value (in contrast to a first difference value described below), of a parameter difference (P2−P1) between the ambient parameter values P1, P2 respectively detected in operating ranges B1, B2, is created, and it is checked whether this second difference value is smaller than a specified maximum parameter difference pₘₐₓ. If not, the process returns to fifth step S5, and the sensor behavior is not evaluated based on the currently available diagnostic values D1 and D2. If, however, the test result in the sixth step, S6, is positive, the procedure continues in a seventh step, S7.

In seventh step S7, the comparison between first diagnostic value D1 and second diagnostic value D2 is performed by establishing the already mentioned first difference of a diagnostic difference (D2−D1) between diagnostic values D1, D2, wherein it is checked whether the first difference is greater than a predetermined minimum diagnostic difference Dₘᵢₙ.

If this is the case, the sensor behavior is evaluated as “OK” in eighth step, S8. If, however, the test result in seventh step S7 is negative, the sensor behavior is evaluated as “not OK” in ninth step S9.

Subsequently, the process concludes provisionally in tenth step S10. Tenth step S10 can optionally include additional measures, in particular to debounce the process, such as low-pass filtering. Moreover, tenth step S10—as shown here schematically—can react to first step S1 of first part I and can optionally influence at least one starting condition, for example by providing feedback on a system time of the performed evaluation, or by influencing certain parameters for debouncing. At the same time, however, the second part II of the process is also continued in fifth step S5.

The process is optionally carried out continuously during the operation of power device 1. Alternatively, however, it is also possible for the process to be carried out only intermittently, for example at predetermined temporal intervals, in particular measured in operating hours, at specified operating times, or depending on a specific occasion.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for operating a power device, the method comprising the steps of:
operating the power device in a first specified operating range;
detecting a first diagnostic value of a sensor while the power device is operated in the first specified operating range;
operating the power device in a second specified operating range, which is different from the first specified operating range;
detecting a second diagnostic value of the sensor while the power device is operated in the second specified operating range; and
evaluating a sensor behavior of the sensor by comparing the first diagnostic value and the second diagnostic value.

2. The method according to claim 1, wherein the first specified operating range and the second specified operating range are selected such that the first diagnostic value and the second diagnostic value differ from one another by more than a specified distance value when the sensor is operational.

3. The method according to claim 2, wherein the first specified operating range and the second specified operating range are adapted to the sensor.

4. The method according to claim 1, wherein the first specified operating range and the second specified operating range are respectively a first specified load range and a second specified load range, wherein at least one of:
(i) at least one of the first specified load range and the second specified load range is limited by a respective lower speed limit and a respective upper speed limit;
(ii) at least one of the first specified load range and the second specified load range is limited by a respective lower torque limit and a respective upper torque limit;
(iii) a finite speed interval is provided between a first upper speed limit of the first specified load range and a second lower speed limit of the second specified load range; and
(iv) a finite torque interval is provided between a first upper torque limit of the first specified load range and a second lower torque limit of the second specified load range.

5. The method according to claim 4, wherein a lower load is assigned to the first specified load range than to the second specified load range.

6. The method according to claim 1, wherein, as at least one of the first diagnostic value and the second diagnostic value, (i) a measured value of the sensor or (ii) an average value derived from a plurality of measured values of the sensor is captured.

7. The method according to claim 1, wherein the comparing between the first diagnostic value and the second diagnostic value is performed by establishing a first difference amount of a diagnostic difference between the first diagnostic value and the second diagnostic value, wherein the first difference amount is compared with a specified minimum diagnostic difference.

8. The method according to claim 7, wherein at least one of:
(i) the sensor behavior is evaluated as “OK” if the first difference amount is greater than the specified minimum diagnostic difference; and
(ii) the sensor behavior is evaluated as not “OK” if the first difference amount is less than the specified minimum diagnostic difference.

9. The method according to 1, wherein, for at least one of the first specified operating range and the second specified operating range, the method includes checking whether the power device is operated in at least one of the first specified operating range and the first specified operating range for a specified operating range-operating period, wherein at least one of the first diagnostic value and the second diagnostic value assigned to at least one of the first specified operating range and the second specified operating range is only detected if the power device is operated in at least one of the first specified operating range and the second specified operating range for the specified operating range-operating period.

10. The method according to claim 1, wherein, in each of the first specified operating range and the second specified operating range, a first environmental parameter value and a second environmental parameter value of an environmental parameter influencing or characterizing said first diagnostic value and said second diagnostic value respectively is detected.

11. The method according to claim 10, wherein the method includes checking, based on the first environmental parameter value and the second environmental parameter value which are detected, whether the evaluating of the sensor behavior is negatively affected by a change in the environmental parameter.

12. The method according to claim 10, wherein the evaluating of the sensor behavior of the sensor based on the comparing of the first diagnostic value and the second diagnostic value occurs only if the evaluating of the sensor behavior being not negatively affected by the change in the environmental parameter is determined, based on the first environmental parameter value and the second environmental parameter value which are detected.

13. The method according to claim 10, wherein the sensor behavior of the sensor is evaluated by comparing the first diagnostic value and the second diagnostic value only if a second difference amount of a parameter difference between the first environmental parameter value and the second environmental parameter value detected in the first specified operating range and the second specified operating range respectively is less than a specified maximum parameter difference.

14. The method according to claim 1, wherein the sensor is a pressure sensor or a temperature sensor.

15. A control device for a power device, the control device comprising:
the control device, which is configured to carry out a method for operating the power device, the method including the steps of:
operating the power device in a first specified operating range;
detecting a first diagnostic value of a sensor while the power device is operated in the first specified operating range;
operating the power device in a second specified operating range, which is different from the first specified operating range;
detecting a second diagnostic value of the sensor while the power device is operated in the second specified operating range; and
evaluating a sensor behavior of the sensor by comparing the first diagnostic value and the second diagnostic value.

16. A power device, comprising:
at least one sensor; and
a control device, which is operatively connected with the at least one sensor and is configured to evaluate a sensor behavior of the at least one sensor, the control device being configured to carry out a method for operating the power device, the method including the steps of:
operating the power device in a first specified operating range;
detecting a first diagnostic value of the at least one sensor while the power device is operated in the first specified operating range;
operating the power device in a second specified operating range, which is different from the first specified operating range;
detecting a second diagnostic value of the at least one sensor while the power device is operated in the second specified operating range; and
evaluating the sensor behavior of the at least one sensor by comparing the first diagnostic value and the second diagnostic value.
